(19) United States
(12) Patent Application Publication
(10) Pub. No.: US 2015/0239149 A1
(43) Pub. Date: Aug. 27, 2015

(54) PROCESS FOR MANUFACTURING ROCK FOR ORNAMENTAL AQUARIUMS

(71) Applicant: Christian Douglas Cavanagh, Fort Myers, FL (US)

(72) Inventor: Christian Douglas Cavanagh, Fort Myers, FL (US)

(21) Appl. No.: 14/628,329

(22) Filed: Feb. 23, 2015

Related U.S. Application Data
(60) Provisional application No. 61/943,541, filed on Feb. 24, 2014.

(51) Int. Cl. B28B 1/14; B44F 9/04

(52) U.S. Cl. CPC B28B 1/14; B44F 9/04

(57) ABSTRACT

A method for creating ornamental rock in which aragonite sand, white Portland cement, amorphous volcanic glass, and a pozzolan are combined to form a casted rock. The casted rock is separated into ornamental rocks. The ornamental rock is then placed into a container with a system for delivering muriatic acid to ensure that a proper pH is reached. Once a designated pH is reached, the ornamental rocks may be removed from the container, washed and dried.

### FIELD OF THE INVENTION

The present disclosure generally relates to a method for creating ornamental rocks for aquariums. More particularly, the present disclosure relates to a method for creating ornamental rock, which is capable of placement in tanks without toxic disrupting a pH of the tank.

### BACKGROUND OF THE INVENTION

The present invention provides a method to generate artificial rocks comparable with real rocks that may be placed in a tank or aquarium for ornamental purposes.

Many aquarium owners decorate their aquariums with rocks and other decorative objects. In general, when introducing foreign objects into an aquarium, it is important to maintain a consistent pH level. As aquatic flora and fauna are highly susceptible to changes in pH, any slight disturbance can prove toxic. Traditionally, rocks are harvested from the environment to ensure proper pH for aquarium introduction. This, however, results in possible loss of habitat and depletion of natural resources. Not only does this deplete natural resources, but the harvested rock isn't guaranteed to be safe for aquarium livestock. Despite the rock having a pH level suitable for introduction into the aquarium, rocks which are harvested from natural sites may also carry parasites and other microbes which can threaten or be toxic to aquarium livestock.

What is desired is a process to create artificial rock which minimizes the amount of time required to produce the rock, ensures that the rock will not permanently alter the pH (or other chemistries) of the aquarium, ensures that the rock is free from any parasites, and utilizes renewable energies. What is also desired is a rock which is light, easily drilled, and porous.

### SUMMARY OF THE INVENTION

The basic inventive concept provides a method for creating artificial rock for introduction into an aquarium.

A first aspect of the present invention provides a method for creating ornamental rock for aquariums comprising creating a mixture of two parts aragonite sand, one part white Portland cement, and two parts amorphous volcanic glass, by volume; adding 10% by weight of pozzolan to the mixture; adding water until the mixture is saturated; casting the mixture; and curing the mixture.

In another aspect of the invention, the pozzolan is pozzolanic metakaolin.

In a further aspect of the invention, after water is added, the mixture is mixed for one to two minutes.

In yet another aspect of the invention, casting the mixtures comprises the steps of dropping the mixture into molds which resemble rocks to form a plurality of casts; covering the casts with a pre-moistened fabric; and allowing the casts to sit for sixteen to twenty hours.

In a further aspect of the invention, the pre-moistened fabric is burlap.

In yet another aspect of the invention, the casts are broken into smaller pieces to form ornamental rocks, which are then placed into a container, covered with a damp fabric, and stored for 28 days.

In another aspect of the invention, the ornamental rocks are stored at a temperature above 75 degrees Farenheit and at a humidity above 60%.

In another aspect of the invention, the ornamental rocks are removed from the container after 28 days and placed into a second container and completely submerged under water for a period of two weeks, where a water level is maintained to counteract any evaporative losses and a pH level is regulated by addition of an acid when the pH level rises above 9.5.

In a further aspect of the invention, the acid is muriatic acid.

In yet another aspect of the invention, the ornamental rocks are maintained in the second container after the period of two weeks for an additional three days without regulating the pH, after which if the pH level is at or above 10, the pH level is regulated again for a period of one week at a time, until the pH level is below 10.

In another aspect of the invention, a testing procedure is repeated until the ornamental rocks are ready to be removed, where the testing procedure comprises removing a small batch of ornamental rocks from the second container, leaving a remainder of ornamental rocks in the second container; washing the small batch of ornamental rocks; allowing the small batch of ornamental rocks to dry; and introducing the small batch of ornamental rocks into an aquarium for at least two days; where after the at least two days, if a pH level in the aquarium is less than 9.5 the remainder of ornamental rocks are ready to be removed, otherwise the remainder of ornamental rocks are left in the second container, while regulating the pH level to be below 9.5, for a period of two weeks.

In a further aspect of the invention, the remainder of ornamental rocks are removed from the second container, washed, and allowed to dry in a dry environment for at least two days.

In yet another aspect of the invention, after the remainder of ornamental rocks are allowed to dry, a stain is applied and the remainder of ornamental rocks are allowed to dry for an additional two days.

As a second aspect of the invention, an ornamental aquarium rock is claimed comprising two parts aragonite sand, one part white Portland cement, two parts amorphous volcanic glass, by volume and 10% by weight of pozzolan.

In yet another aspect of the invention, the pozzolan is pozzolanic metakaolin.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, where like numerals denote like elements and in which:

FIG. 1 presents a process flow chart for preparation of an artificial ornamental rock for introduction into an aquarium;

FIG. 2 depicts an alternate embodiment of the process shown in FIG. 1 in which the artificial ornamental rock process contains the step of applying a stain;

FIG. 3 presents a detailed process flow chart for the rock formation process as shown in FIG. 1;

FIG. 4 presents a detailed process flow chart for ensuring a rock pH, as created by the process of FIG. 1, will not permanently alter that of an aquarium; and

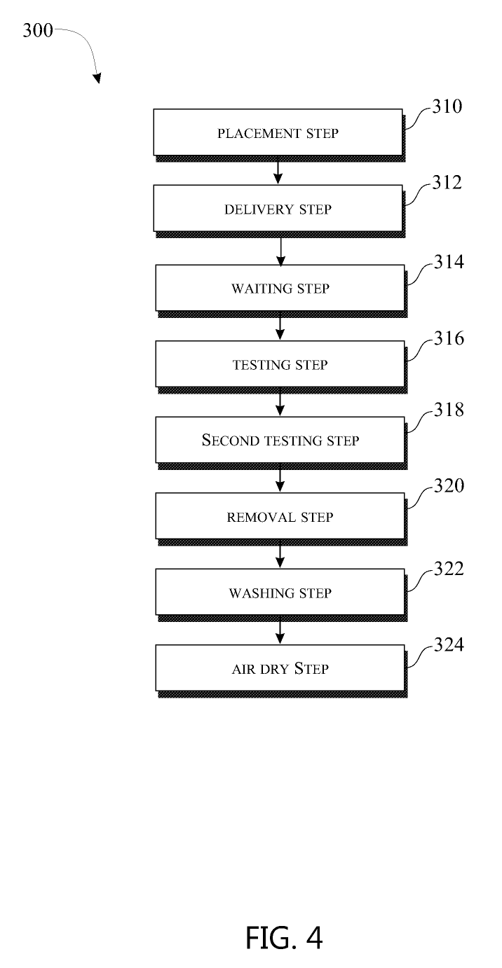

FIG. 5 presents a detailed flow chart illustrating a staining step, as illustrated in the alternate embodiment of FIG. 2.

Like reference numerals refer to like parts throughout the various views of the drawings.

### DETAILED DESCRIPTION OF THE INVENTION

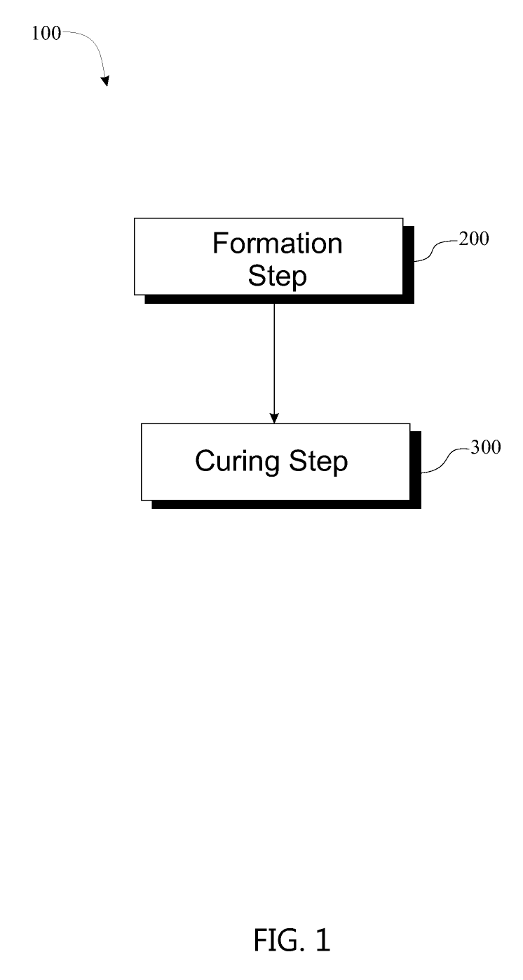

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

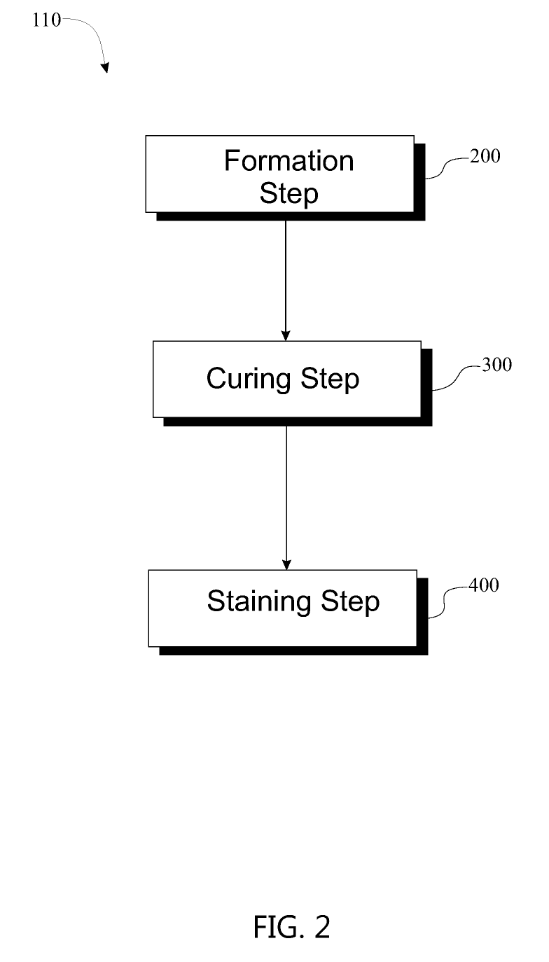

An ornamental rock creation process 100 is depicted in FIG. 1. The ornamental rock creation process broadly comprises a formation step 200 and a curing step 300. In an alternative embodiment, a stained ornamental rock creation process 110, as depicted in FIG. 2, comprises a formation step 200, a curing step 300, and a staining step 400.

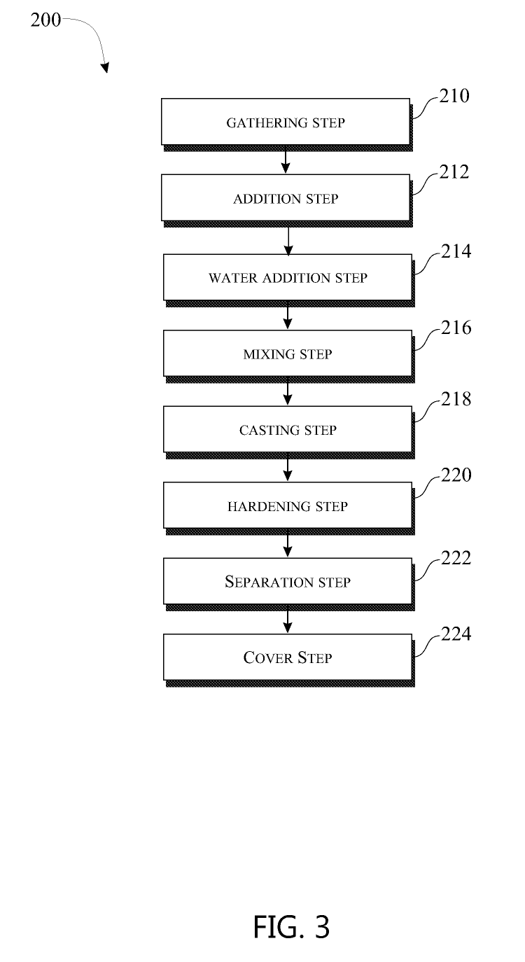

The formation step 200 is further illustrated in FIG. 3. The formation step 200 begins with a gathering step 210. In the gathering step 210, two parts aragonite sand are mixed with one part white Portland cement and two parts amorphous volcanic glass, by volume. For exemplary purposes, the amorphous volcanic glass may be perlite. After the components of the gathering step 210 are combined, up to, but not less than, ten percent of a pozzolan by volume is added in an addition step 212, creating a rock mixture. For exemplary purposes, the pozzolan may be pozzolanic metakaolin. After the addition step 212, water is added to the rock mixture until saturation, in a water addition step 214. Saturation is noted when the mixture reaches an oatmeal-like consistency. After the water addition step 214, a mixing step 216 is contemplated in which the rock mixture is further mixed in a mixing apparatus for at least one, but not more than two minutes. For illustrative purposes only, the mixing apparatus may be a cement mixer. Once the mixing step 216 is complete, the rock mixture is cast into casted rocks in a casting step 218. In the casting step 218, the rock mixture may be poured directly into a cast with a rock shape or other shapes, as desired. Furthermore, the rock mixture may be poured into such casts by drizzling, or other method, to promote certain textures upon hardening. In a hardening step 220, the casted rocks are covered with a moist fabric and allowed to harden for a period of at least 16 hours, or until hardened. For illustrative purposes, the fabric used to cover the casted rocks is burlap. After the casted rocks have hardened in the hardening step 220, the casted rocks are separated from the mold or cast into a plurality of ornamental rocks in a separation step 222. The casted rocks may be separated by the use of a separation tool. For illustrative purposes, the separation tool may be a hammer and a chisel. In a cover step 224, the ornamental rocks are placed into a container and covered with a fabric, such as burlap, for a period of twenty-eight days.

After the formation step 200, the ornamental rocks then enter a curing step 300. In a placement step 310, the ornamental rocks are placed into a curing container. The curing container is filled with water and is equipped with a muriatic acid delivery system. In a delivery step 312, the muriatic acid delivery system is designed to measure a pH and then deliver muriatic acid to the curing container if the measured pH is greater than 9.5. In a waiting step 314, the muriatic acid delivery system is allowed to run for a period of two weeks. If at any time during the waiting step 314 the water level of the curing container falls to the point where it no longer covers the ornamental rocks, additional water is added to the curing container. At the end of the period of two weeks, the muriatic acid delivery system is turned off for three days. After the waiting step 314, a pH measurement is made of the curing container in a testing step 316. Further in the testing step 316, if the pH measurement is above 10, the muriatic acid delivery system is restarted for a period of seven days. The testing step 316 is repeated until the pH measurement is below 10. Once the pH measurement is below 10, a second testing step 318 is commenced. In the second testing step 318, a small batch of the ornamental rocks is removed from the curing container, leaving a remainder of ornamental rocks. The small batch is then washed with water, and allowed to air dry for two days. As a further element of the second testing step 318, the small batch is placed in a test aquarium and allowed to sit for at least two days before a pH measurement is taken of the aquarium. If the pH measurement of the aquarium is above 9.5, the muriatic acid delivery system is turned and allowed to operate for two weeks. The second testing step 318 is repeated until the pH measurement of the aquarium is below 9.5. Once the pH measurement of the aquarium is below 9.5, the remainder of the ornamental rock is removed from the curing container in a removal step 320. After the removal step 320, the ornamental rock is washed with water in a washing step 322 and allowed to air dry in an air dry step 324. Once the ornamental rock is dry, it can be introduced safely into an aquarium.

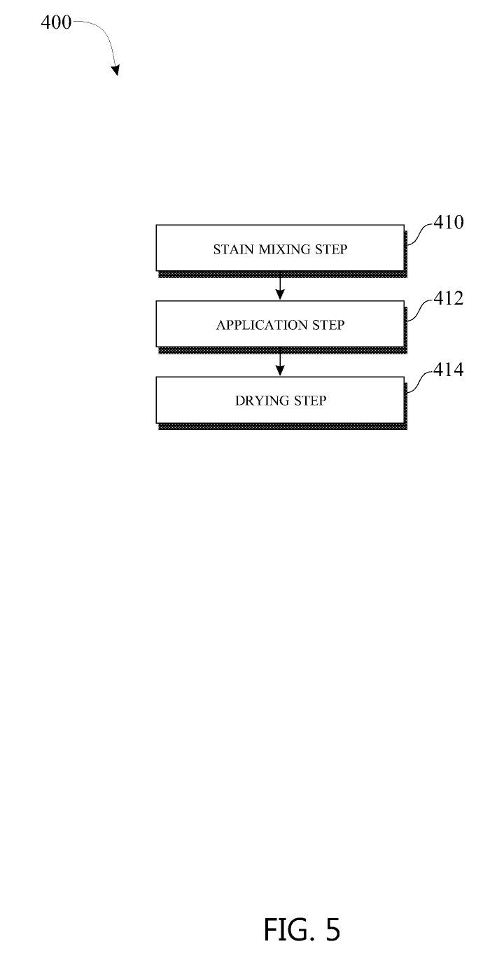

In an alternate embodiment, as shown in FIG. 2, a stained ornamental rock creation process 110 optionally includes a staining step 400, which occurs after the curing step 300. The staining step 400 is further detailed in FIG. 5. Here, a stain is mixed in a stain mixing step 410. As before, it is important select a stain which will not alter the pH of an aquarium. Once the stain is mixed, it is applied to the ornamental rock in an application step 412, preferably by misting the ornamental rock, to create stained ornamental rock. After the application step 412, the stained ornamental rock is allowed to dry in a drying step 414. After the drying step 414, the stained ornamental rock may be introduced into an aquarium.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A method for creating ornamental rock for aquariums comprising:
creating a mixture of two parts aragonite sand, one part white Portland cement, and two parts amorphous volcanic glass, by volume;
adding 10% by weight of pozzolan to the mixture;
adding water until the mixture is saturated;
casting the mixture; and
curing the mixture.

2. The method of claim 1, wherein the pozzolan is pozzolanic metakaolin.

3. The method of claim 1, wherein after water is added, the mixture is mixed for a one to two minutes.

4. The method of claim 3, wherein casting the mixture comprises the steps of:
dropping the mixture into molds which resemble rocks to form a plurality of casts;
covering the casts with a pre-moistened fabric; and
allowing the casts to sit for sixteen to twenty hours.

5. The method of claim 4, wherein the pre-moistened fabric is burlap.

6. The method of claim 4, wherein the casts are broken into smaller pieces to form ornamental rocks, which are then placed into a container, covered with a damp fabric, and stored for 28 days.

7. The method of claim 6, wherein the ornamental rocks are stored at a temperature above 75 degrees Farenheit and at a humidity above 60%.

8. The method of claim 6, wherein the ornamental rocks are removed from the container after 28 days and placed into a second container and completely submerged under water for a period of two weeks, where a water level is maintained to counteract any evaporative losses and a pH level is regulated by addition of an acid when the pH level rises above 9.5.

9. The method of claim 8, wherein the acid is muriatic acid.

10. The method of claim 8, wherein the ornamental rocks are maintained in the second container after the period of two weeks for an additional three days without regulating the pH, after which if the pH level is at or above 10, the pH level is regulated again for a period of one week at a time, until the pH level is below 10.

11. The method of claim 10, wherein a testing procedure is repeated until the ornamental rocks are ready to be removed, where the testing procedure comprises:
removing a small batch of ornamental rocks from the second container, leaving a remainder of ornamental rocks in the second container;
washing the small batch of ornamental rocks;
allowing the small batch of ornamental rocks to dry; and
introducing the small batch of ornamental rocks into an aquarium for at least two days;
where after the at least two days, if a pH level in the aquarium is less than 9.5 the remainder of ornamental rocks are ready to be removed, otherwise the remainder of ornamental rocks are left in the second container, while regulating the pH level to be below 9.5, for a period of two weeks.

12. The method of claim 11, wherein the remainder of ornamental rocks are removed from the second container, washed, and allowed to dry in a dry environment for at least two days.

13. The method of claim 12, wherein after the remainder of ornamental rocks are allowed to dry, a stain is applied and the remainder of ornamental rocks are allowed to dry for an additional two days.

14. An ornamental aquarium rock comprising two parts aragonite sand, one part white Portland cement, two parts amorphous volcanic glass, by volume and 10% by weight of pozzolan.

15. The ornamental aquarium rock of claim 14, wherein the pozzolan is pozzolanic metakaolin.
